(19) United States
(12) Patent Application Publication
(10) Pub. No.: US 2026/0045514 A1
(43) Pub. Date: Feb. 12, 2026

(54) Electrode and Method for Manufacturing Electrode

(71) Applicant: LG ENERGY SOLUTION, LTD., Seoul (KR)

(72) Inventors: Mi-Ru Jo, Daejeon (KR); Sung-Bin Park, Daejeon (KR); Sung-Hwan Kim, Daejeon (KR); Seok-Kyeong Lee, Daejeon (KR); Woo-Hyung Cho, Daejeon (KR)

(73) Assignee: LG ENERGY SOLUTION, LTD., Seoul (KR)

(21) Appl. No.: 18/714,220

(22) PCT Filed: Dec. 23, 2022
(86) PCT No.: PCT/KR2022/021248

§ 371 Date: Aug. 28, 2025

(30) Foreign Application Priority Data
Dec. 24, 2021 (KR) 10-2021-0187849

(51) Int. Cl. H01M 4/70; H01M 4/02; H01M 4/04; H01M 10/052

(52) U.S. Cl. CPC H01M 4/70; H01M 4/0404; H01M 4/043; H01M 4/0471; H01M 10/052; H01M 2004/021

(57) ABSTRACT

Disclosed are an electrode and a method for manufacturing the same. The electrode includes: a current collector; and an electrode layer disposed on at least one surface of the current collector and a non-coated portion having no electrode layer, wherein the vertical section of the electrode layer is provided with a central portion of the electrode layer, and an end portion that is extended from each of both sides of the central portion of the electrode layer and is in contact with the current collector, while the height of the central portion of the electrode layer decreases, the electrode layer shows a slope of the end portion of 80-90°, and the slope of the end portion refers to an angle formed by a boundary point at which the end portion of the electrode layer contacts the current collector, between the tangent line in contact with the end portion and one surface of the current collector facing the electrode layer.

### TECHNICAL FIELD

The present disclosure relates to an electrode and a method for manufacturing an electrode. Particularly, the present disclosure relates to an electrode favorable to long-term life and quick charging and a method for manufacturing the electrode.

The present application claims priority to Korean Patent Application No. 10-2021-0187849 filed on Dec. 24, 2021 in the Republic of Korea, the disclosures of which are incorporated herein by reference.

### BACKGROUND ART

As technical development and needs for mobile instruments have been increased, secondary batteries as energy sources have been increasingly in demand, and thus active studies have been conducted about batteries capable of meeting various needs.

Such a secondary battery may be broadly divided into a positive electrode, a negative electrode, a separator and an electrolyte. Lithium ions reciprocate between both electrodes, while being deintercalated from the positive electrode active material upon the first charge, intercalated into the negative electrode active material, and then deintercalated upon the subsequent discharge. The lithium secondary battery is rechargeable by converting energy through the above-mentioned process.

In general, an electrode of a lithium secondary battery is prepared by dispersing an electrode active material, a binder, or the like, to prepare an active material slurry, and coating an active material layer on one surface of a current collector. When coating the active material slurry on one surface of a current collector, a sliding phenomenon occurs, wherein the active material slurry spreads. Due to this, a sliding portion having a smaller thickness as compared to the central portion is formed at the end of the active material layer. Particularly, the sliding portion may refer to a portion extended from each of both ends of the central portion and having a thickness decreasing gradually toward the end of the active material layer, i.e. from the central portion of the active material layer to the non-coated portion having no active material layer. Due to such a sliding phenomenon, both ends of the active material layer have a lower loading amount as compared to the central portion. Therefore, there is a problem in that the secondary battery realizes a lower capacity as compared to the designed capacity thereof.

In addition, the ratio of the positive electrode to the negative electrode may be reversed at the non-coated portion (tab portion) of the electrode due to the above-mentioned sliding portion generated at the non-coated portion of the electrode end portion, a physical gap may be generated, and the sliding portion may be controlled hardly, thereby making it difficult to maintain stable electrode quality.

### DISCLOSURE

### Technical Problem

The present disclosure is designed to solve the problems of the related art, and therefore the present disclosure is directed to providing an electrode favorable to long-term life and quick charging and a method for manufacturing the electrode.

### Technical Solution

In one aspect of the present disclosure, there are provided an electrode and a method for manufacturing the electrode according to the following embodiments.

According to the first embodiment of the present disclosure, there is provided an electrode, including: a current collector; and an electrode layer disposed on at least one surface of the current collector and a non-coated portion having no electrode layer,
wherein the vertical section of the electrode layer is provided with a central portion of the electrode layer, and an end portion that is extended from each of both sides of the central portion of the electrode layer and is in contact with the current collector, while the height of the central portion of the electrode layer decreases,
the electrode layer shows a slope of the end portion of 80-90°, and
the slope of the end portion refers to an angle formed by a boundary point at which the end portion of the electrode layer contacts the current collector, between the tangent line in contact with the end portion and one surface of the current collector facing the electrode layer.

According to the second embodiment of the present disclosure, there is provided the electrode as defined in the first embodiment, wherein the electrode layer shows a slope of the end portion of 85-90°.

According to the third embodiment of the present disclosure, there is provided the electrode as defined in the first or the second embodiment, wherein the electrode layer has a length of the end portion of 10 mm or less, the length of the end portion refers to a distance between a vertically downward facing point of the slope start point to the current collector and a boundary point at which the end portion of the electrode layer contacts the current collector, and the slope start point is a position on the end portion having an acute angle of 10° or more for the first time, when the acute angle formed by an extension line of the central portion of the electrode layer and the tangent line on the end portion along the end portion extended from the central portion is measured.

According to the fourth embodiment of the present disclosure, there is provided a method for manufacturing the electrode as defined in any one of the first to the third embodiments, including the steps of:
applying a slurry for an electrode layer to at least one surface of an electrode current collector in such a manner that a non-coated portion may be formed at the top end portion adjacent to one end of the current collector, followed by drying, to form an electrode layer;
pressing the electrode current collector on which the electrode layer is formed; and
removing a sliding portion of the electrode layer formed at the boundary portion to the non-coated portion after the pressing.

According to the fifth embodiment of the present disclosure, there is provided the method for manufacturing the electrode as defined in the fourth embodiment, wherein the sliding portion is removed by using laser ablation.

According to the sixth embodiment of the present disclosure, there is provided the method for manufacturing the electrode as defined in the fifth embodiment, wherein the laser ablation is carried out by using a femtosecond laser.

According to the seventh embodiment of the present disclosure, there is provided the method for manufacturing the electrode as defined in any one of the fourth to the sixth embodiments, wherein the sliding portion of the electrode layer is removed after the pressing, or after the pressing and notching.

According to the eighth embodiment of the present disclosure, there is provided the method for manufacturing the electrode as defined in any one of the fourth to the seventh embodiments, wherein the sliding portion of the electrode layer is removed up to 10 mm or less from the boundary with the non-coated portion.

According to the ninth embodiment of the present disclosure, there is provided a secondary battery including the electrode as defined in any one of the first to the third embodiments.

According to the tenth embodiment of the present disclosure, there is provided the secondary battery as defined in the ninth embodiment, which is a lithium secondary battery.

### Advantageous Effects

According to an embodiment of the present disclosure, the sliding portion of an electrode generated at the non-coated portion disposed at each of both end portions of the electrode due to a slurry spreading phenomenon caused by wet coating of the electrode layer is removed to prevent a reversal phenomenon of capacity balance (N/P balance) between a positive electrode and a negative electrode. As a result, it is possible to inhibit Li deposition occurring conventionally in the sliding portion and to improve the cycle characteristics of a secondary battery using the electrode. In addition, according to an embodiment of the present disclosure, the physical distance between a positive electrode layer and a negative electrode layer is reduced, and thus an over-voltage phenomenon may be reduced by preventing a gradient in lithium-ion concentration between the positive electrode and the negative electrode, i.e. a phenomenon of polarization of electrolyte concentration.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a schematic view illustrating the electrode according to the related art.

FIG. 2 is a graph illustrating a change in thickness depending on the length of the electrode layer, before and after pressing the electrode of FIG. 1 according to the related art.

FIG. 3 is a schematic view illustrating the electrode according to an embodiment of the present disclosure.

FIG. 4 is a graph illustrating a change in thickness depending on the length of the electrode layer, before and after pressing the electrode of FIG. 3 according to an embodiment of the present disclosure.

FIG. 5 illustrates the definition of the slope of the end portion of the electrode according to an embodiment of the present disclosure.

FIG. 6 illustrates the definition of the length of the end portion of the electrode according to an embodiment of the present disclosure.

FIG. 7 is a schematic view illustrating the method for manufacturing an electrode according to an embodiment of the present disclosure.

FIG. 8 is a schematic sectional view illustrating the electrode assembly according to the related art.

FIG. 9 is a schematic sectional view illustrating the electrode assembly according to an embodiment of the present disclosure.

FIG. 10 is a schematic sectional view illustrating the electrode according to an embodiment of the present disclosure.

FIG. 11 is a schematic sectional view illustrating the electrode according to the related art.

FIG. 12 is a graph illustrating the cycle characteristics of Example 1 and Comparative Example 1.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

In the case of the electrode according to the related art, wet coating is performed on a current collector, and thus sliding portions are generated inevitably at both ends of the wet coated electrode layer due to a slurry spreading phenomenon, which leads to a reversal phenomenon of capacity balance (N/P balance) between the positive electrode and the negative electrode in an electrochemical device using the electrode having such sliding portions, resulting in lithium (Li) deposition and deterioration of the electrochemical device.

To solve the above-mentioned problems of the electrode according to the related art, the present disclosure provides an electrode, including: a current collector; and an electrode layer disposed on at least one surface of the current collector and a non-coated portion having no electrode layer,
wherein the vertical section of the electrode layer is provided with a central portion of the electrode layer, and an end portion that is extended from each of both sides of the central portion of the electrode layer and is in contact with the current collector, while the height of the central portion of the electrode layer decreases,
the electrode layer shows a slope of the end portion of 80-90°, and
the slope of the end portion refers to an angle formed by a boundary point at which the end portion of the electrode layer contacts the current collector, between the tangent line in contact with the end portion and one surface of the current collector facing the electrode layer.

In other words, the electrode according to the present disclosure is characterized in that the sliding portions of the electrode, which cause degradation of the performance of a secondary battery, such as a reversal phenomenon of capacity balance between the positive electrode and the negative electrode, are removed to minimize a difference between the height and capacity per unit area of the central portion of the electrode layer and those of the end portion of the electrode layer.

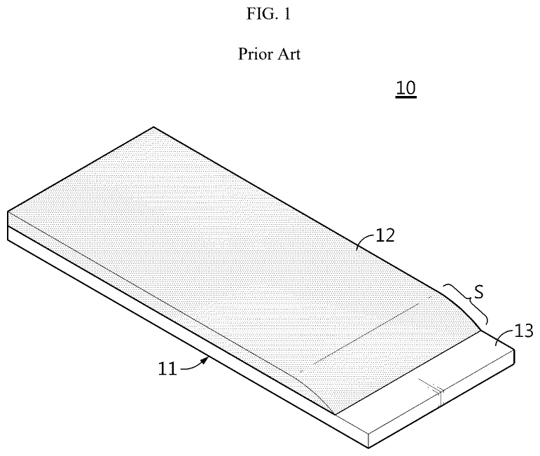

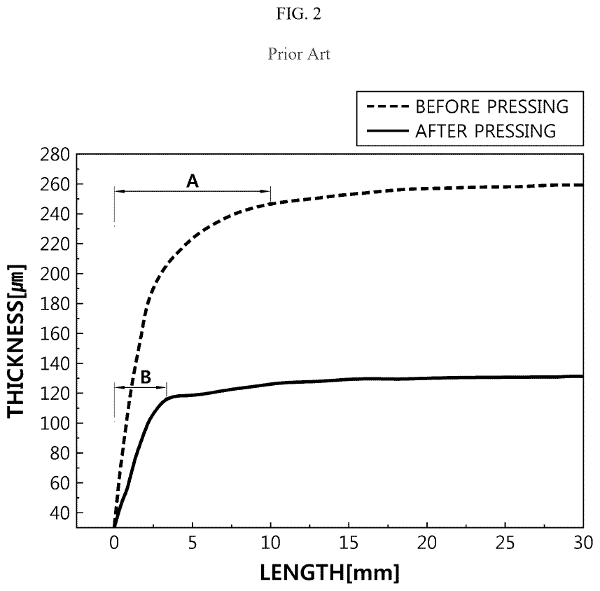

FIG. 1 is a schematic view illustrating the electrode according to the related art, and FIG. 2 is a graph illustrating a change in thickness depending on the length of the electrode layer, before and after pressing the electrode of FIG. 1 according to the related art.

Referring to FIG. 1, the electrode 10 according to the related art is provided with an electrode layer 12 having a sliding portion S at the end portion, and a non-coated portion 13 where no electrode layer is present and the surface of a current collector is exposed, on one surface of the current collector 11.

Referring to FIG. 2, as can be seen from the thickness of the electrode layer depending on the length from the end portion of the electrode layer, before and after pressing, the length A of the electrode layer extended to the end portion of the electrode layer, while showing a decrease in the height of the central portion of the electrode layer before pressing, is slightly reduced to the length B of the electrode layer extended to the end portion of the electrode layer, while showing a decrease in the height of the central portion of the electrode layer after pressing. However, the length B is still retained significantly. The region of the electrode layer corresponding to the length B becomes the sliding portion, which may cause degradation of the performance of a secondary battery.

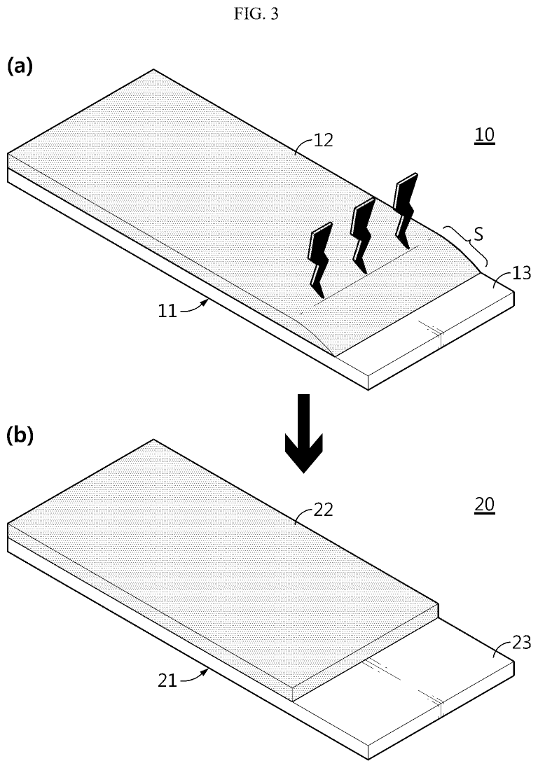

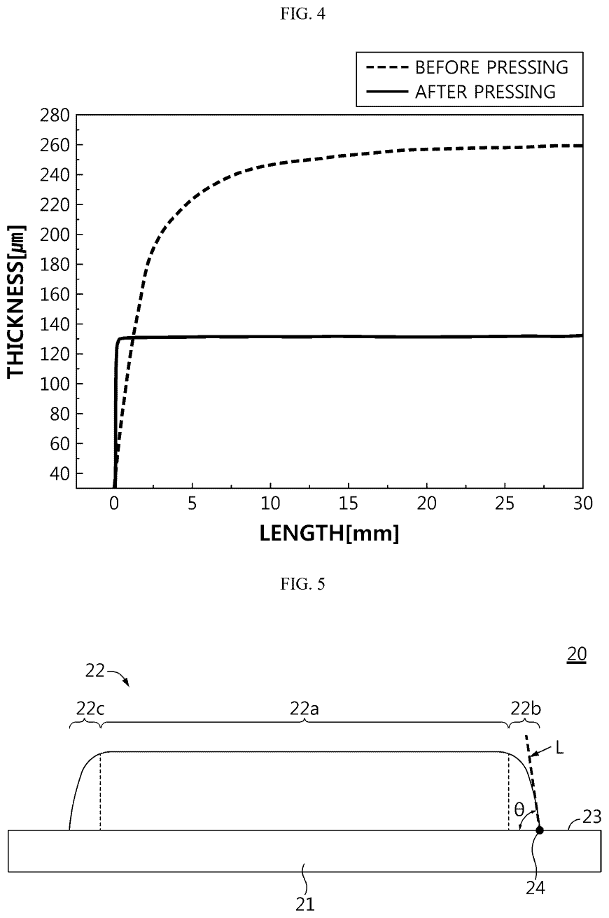

Meanwhile, FIG. 3 is a schematic view illustrating the electrode according to an embodiment of the present disclosure, and FIG. 4 is a graph illustrating a change in thickness depending on the length of the electrode layer, before and after pressing the electrode of FIG. 3 according to an embodiment of the present disclosure.

In FIG. 3, after removing the sliding portion S of the electrode 10 according to the related art by the method as described hereinafter, the electrode 20 according to an embodiment of the present disclosure is provided with an electrode layer 22 where the sliding portion is removed and a non-coated portion 23, on one surface of a current collector 21.

Referring to FIG. 4, the electrode 20 provided with the electrode layer 22 from which the sliding portion is removed according to an embodiment of the present disclosure substantially has no length of the electrode layer extended to the end portion of the electrode layer, while showing a decrease in the height of the central portion of the electrode layer after pressing, as compared to the length of the electrode layer before pressing. In other words, the electrode has an electrode layer extended to the end portion thereof substantially vertically from the height of the central portion with no sliding portion.

FIG. 5 illustrates the definition of the slope of the end portion of the electrode according to an embodiment of the present disclosure.

Referring to FIG. 5, the electrode 20 according to an embodiment of the present disclosure includes: a current collector 21; and an electrode layer 22 disposed on at least one surface of the current collector 21 and a non-coated portion 23 having no electrode layer, wherein the vertical section of the electrode layer 22 is provided with a central portion 22a of the electrode layer; and an end portion 22b, 22c extended from each of both sides of the central portion 22a of the electrode layer and contacts the current collector, while the height of the central portion of the electrode layer decreases.

Herein, the slope θ of the end portion refers to an angle formed by a boundary point 24 at which the end portion of the electrode layer contacts the current collector, between the tangent line L in contact with the end portion and one surface of the current collector 21 facing the electrode layer.

In addition, the slope of the end portion of the electrode layer according to the present disclosure may be 80-90°. According to an embodiment of the present disclosure, the slope of the end portion may be 85-90°.

When the slope of the end portion of the electrode layer satisfies the above-defined range, it is possible to prevent a reversal phenomenon of capacity balance (N/P balance) between a positive electrode and a negative electrode, to inhibit Li deposition by calculating the concentration of an electrolyte generated at the sliding portion, to improve the over-voltage and cycle characteristics of a secondary battery using the electrode, and to improve the adhesion between the electrode and a separator at the end portion.

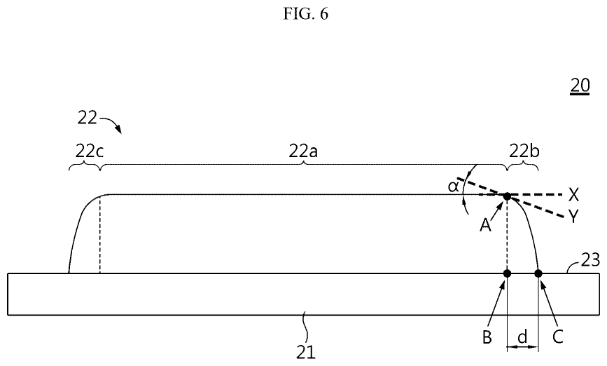

Referring to FIG. 6, the electrode 20 according to an embodiment of the present disclosure includes: a current collector 21; and an electrode layer 22 disposed on at least one surface of the current collector 21 and a non-coated portion 23 having no electrode layer, wherein the vertical section of the electrode layer 22 is provided with a central portion 22a of the electrode layer; and an end portion 22b, 22c extended from each of both sides of the central portion 22a of the electrode layer and contacts the current collector, while the height of the central portion of the electrode layer decreases.

Herein, the length d of the end portion of the electrode layer refers to a distance between a vertically downward facing point B of the slope start point A to the current collector 21 and a boundary point C at which the end portion of the electrode layer contacts the current collector, and the slope start point A may be a position on the end portion having an acute angle α of 10° or more for the first time, when the acute angle α formed by an extension line X of the central portion of the electrode layer and the tangent line Y on the end portion along the end portion extended from the central portion is measured. In other words, the slope start point may refer to a position on the end portion having an acute angle α of 10° or more for the first time, when the acute angle α formed by the extension line X of the central portion of the electrode layer and the tangent line Y at an optional position on the end portion is measured, along the direction from the optional position on the end portion to the boundary point C, wherein the optional position on the end portion refers to a position where the height starts to be reduced as compared to the height of the electrode layer at the central portion of the electrode layer. When the outer counter of the vertical section of the end portion has a curved shape and becomes in contact with the current collector, while the height of the electrode layer decreases, the position on the end portion having an acute angle α of 10° or more for the first time may be determined, while the optional point on the end portion is changed continuously. On the other hand, when the outer counter of the vertical section of the end portion has a diagonal line or vertical line shape having a predetermined angle of 10° or more and becomes in contact with the current collector, while the height of the electrode layer decreases, the position on the end portion having an acute angle α of 10° or more for the first time may be a point at which the diagonal line or vertical line shape starts.

The length of the end portion of the electrode layer according to the present disclosure may be 10 mm or less. According to an embodiment of the present disclosure, the length of the end portion of the electrode layer may be 4-10 mm, 4-7 mm, or 7-10 mm.

When the end portion of the electrode layer satisfies the above-defined range, it is possible to prevent a reversal phenomenon of capacity balance (N/P balance) between a positive electrode and a negative electrode, to inhibit Li deposition by calculating the concentration of an electrolyte generated at the sliding portion, to improve the over-voltage and cycle characteristics of a secondary battery using the electrode, and to improve the adhesion between the electrode and a separator at the end portion.

According to the present disclosure, the electrode may be a positive electrode or a negative electrode, and the electrode layer may be a positive electrode active material layer or a negative electrode active material layer.

For example, when the electrode is a positive electrode, the active material contained in the positive electrode active material layer is a positive electrode active material, such as a lithium-containing oxide, and a lithium-containing transition metal oxide may be used preferably. Particular examples of the lithium-containing transition metal oxide may include any one selected from the group consisting of Liₓ(NiₐCo_{b}Mn_{c})O₂ (0.5<x<1.3, 0<a<1, 0<b<1, 0<c<1, a+b+c=1), LiₓFePO₄ (0.5<x<1.3), LiₓCoO₂ (0.5<x<1.3), LiₓNiO₂ (0.5<x<1.3), LiₓMnO₂ (0.5<x<1.3), LiₓMn₂O₄ (0.5<x<1.3), LiₓNi_{1-y}Co_{y}O₂ (0.5<x<1.3, 0<y<1), LiₓCo_{1-y}Mn_{y}O₂ (0.5<x<1.3, 0≤y<1), LiₓNi_{1-y}Mn_{y}O₂ (0.5<x<1.3, 0≤y<1), Liₓ(NiₐCo_{b}Mn_{c})O₄ (0.5<x<1.3, 0<a<2, 0<b<2, 0<c<2, a+b+c=2), LiₓMn_{2-z}Ni_{z}O₄ (0.5<x<1.3, 0<z<2), LiₓMn_{2-z}CO₂O₄ (0.5<x<1.3, 0<z<2) and LiₓCoPO₄ (0.5<x<1.3), or a mixture of two or more of them. In addition, the lithium-containing transition metal oxide may be coated with a metal, such as aluminum (Al) or a metal oxide. Further, besides the lithium-containing transition metal oxide, sulfides, selenides and halides may be used.

For example, when the electrode is a negative electrode, particular examples of the negative electrode active material contained in the active material layer include: carbon such as non-graphitizable carbon or graphite-based carbon; metal composite oxides, such as LiₓFe₂O₃ (0≤x≤1), LiₓWO₂ (0≤x≤1) and SnₓMe₁₋ₓMe′_{y}O_{z} (Me: Mn, Fe, Pb, Ge; Me′: Al, B, P, Si, elements of Group 1, 2 or 3 in the Periodic Table, halogen; 0<x≤1; 1≤y≤3; 1≤z≤8); lithium metal; lithium alloy; silicon-based alloy; tin-based alloy; silicon oxides, such as SiO, SiO/C and SiO₂; metal oxides, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ and Bi₂O₅; conductive polymers, such as polyacetylene; Li—Co—Ni type materials; or the like.

The electrode according to an embodiment of the present disclosure may include: a current collector; and an active material layer which is disposed on at least one surface of the current collector and is a region formed by stacking an active material slurry containing an active material, a conductive material and a binder, and a non-coated portion having no active material layer.

According to an embodiment of the present disclosure, the electrode may be a positive electrode, and the active material may be a positive electrode active material. In this case, the positive electrode current collector may be formed to have a thickness of about 3-50 μm. The positive electrode current collector is not particularly limited, as long as it has high conductivity, while not causing any chemical change in the corresponding battery. Particular examples of the positive electrode current collector include stainless steel, aluminum, nickel, titanium, baked carbon, aluminum or stainless steel surface-treated with carbon, nickel, titanium, silver, or the like. In addition, fine surface irregularities may be formed on the surface of the current collector to enhance the binding force with the positive electrode active material. The current collector may be used in various shapes, including a film, a sheet, a foil, a net, a porous body, a foamed body, a non-woven web, or the like. In addition, according to the present disclosure, the conductive material contained in the active material layer is added generally in an amount of 0.2-5 wt % based on the total weight of the mixture including the positive electrode active material. The conductive material is not particularly limited, as long as it has conductivity, while not causing any chemical change in the corresponding battery. Particular examples of the conductive material include: graphite, such as natural graphite or artificial graphite; carbon black, such as acetylene black, ketjen black, channel black, furnace black, lamp black or thermal black; conductive fibers, such as carbon fibers or metal fibers; fluorocarbon; metal powder, such as aluminum or nickel powder; conductive whisker, such as zinc oxide or potassium titanate; conductive metal oxide, such as titanium dioxide; conductive material, such as a polyphenylene derivative; or the like. In addition, the binder contained in the active material layer is an ingredient which assists binding between the active material and the conductive material and binding to the current collector, and is added generally in an amount of 0.2-5 wt % based on the total weight of the slurry including the positive electrode active material. Particular examples of the binder include polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, styrene-butadiene rubber, fluoro-rubber, various copolymers, or the like.

For example, when the electrode is a negative electrode, the negative electrode current collector is not particularly limited, as long as it has high conductivity, while not causing any chemical change in the corresponding battery. Particular examples of the negative electrode current collector include copper, stainless steel, aluminum, nickel, titanium, baked carbon, copper or stainless steel surface-treated with carbon, nickel, titanium, silver, or the like. In addition, the negative electrode current collector may generally have a thickness of 3-50 μm. Similarly to the positive electrode current collector, surface irregularities may be formed on the surface of the current collector to enhance the binding force with the negative electrode active material. For example, the negative electrode current collector may be used in various shapes, including a film, a sheet, a foil, a net, a porous body, a foamed body, a non-woven web, or the like. In addition, the conductive material and binder contained in the active material layer are the same as described above with reference to the positive electrode.

In another aspect of the present disclosure, there is provided a method for manufacturing the electrode, including the steps of:
applying a slurry for an electrode layer to at least one surface of an electrode current collector in such a manner that a non-coated portion may be formed at the top end portion adjacent to one end of the current collector, followed by drying, to form an electrode layer;
pressing the electrode current collector on which the electrode layer is formed; and
removing a sliding portion of the electrode layer formed at the boundary portion to the non-coated portion after the pressing.

Hereinafter, the method for manufacturing the electrode will be explained in detail with reference to FIG. 3.

First, a slurry for an electrode layer is applied to at least one surface of an electrode current collector 11 in such a manner that a non-coated portion 13 may be formed at the top end portion adjacent to one end of the current collector 11, and then dried, to form an electrode layer 12. The electrode layer 12 is provided with a sliding portion S in the region linked to non-coated portion 13, and the sliding portion S is extended to the end portion of the electrode layer which contacts the non-coated portion, while the height of the electrode layer 12 decreases as compared to the height of the central portion.

Next, the electrode current collector having the electrode layer is pressed. Herein, any pressing process may be used, as long as it is one carried out for the conventional electrodes. It is possible to control the thickness of the electrode layer to a desired level through the pressing process.

Then, after the pressing, the sliding portion S of the electrode layer, formed at the boundary between the non-coated portion, i.e. the portion of the current collector having no electrode layer, and the current collector, is removed. The sliding portion is extended from each of both ends of the central portion of the electrode layer, and refers to a portion, i.e. inclined portion, where the thickness is reduced gradually toward the non-coated portion having no electrode layer.

The sliding portion may be removed by using various etching processes used conventionally, as long as such processes cause no physical/chemical change in the remaining electrode layer.

According to an embodiment of the present disclosure, the sliding portion may be removed by using laser ablation.

Herein, laser ablation refers to concentrating laser beams to a sample by using a high-output pulse laser to remove the light-concentrated portion. Referring to FIG. 3, the sliding portion may be removed by carrying out such laser ablation.

The laser ablation may be carried out by using a femtosecond laser.

The femtosecond laser refers to a laser having a very short pulse of several hundreds of fs (10⁻¹⁵ sec.) When using such a short pulse width and high peak output characteristics of the femtosecond laser for laser processing, the time of irradiated laser pulses is shorter than the thermal diffusion time of a material to be processed, and thus non-thermal processing causing no thermal deterioration of the material is allowed. In addition, the femtosecond laser realizes a high peak output even with a relatively smaller energy as compared to the conventional continuous wave or nanosecond laser, and thus less impact is applied to an electrode to be processed to allow ultra-precision fine processing, and fine cracks or burr formation in the electrode may be removed. In addition, there is no impact wave and surface distortion.

When carrying out laser ablation to prevent degradation of the quality and function of the electrode as mentioned above, the output wavelength of the laser beams may be 500-1080 nm, or 800-1030 nm. In addition, the repetition ratio of laser beams may be 300-1000 kHz, and the output may be 10-100 W. When the processing conditions exceed the above-defined ranges, it is difficult to control the process, and thus the electrode current collector may be dissolved. When the processing conditions are less than the above-defined ranges, there is a problem in that the electrode layer at the sliding portion may not be removed.

According to an embodiment of the present disclosure, the sliding portion of the electrode layer may be removed after the pressing, or after the pressing and notching.

In other words, the sliding portion of the electrode layer may be removed after applying a slurry for an electrode layer onto the current collector, followed by drying, to form the electrode layer, and then performing a pressing process to obtain a predetermined height of the electrode layer, or after performing the pressing process and then performing a notching step of forming the non-coated portion into a tab portion.

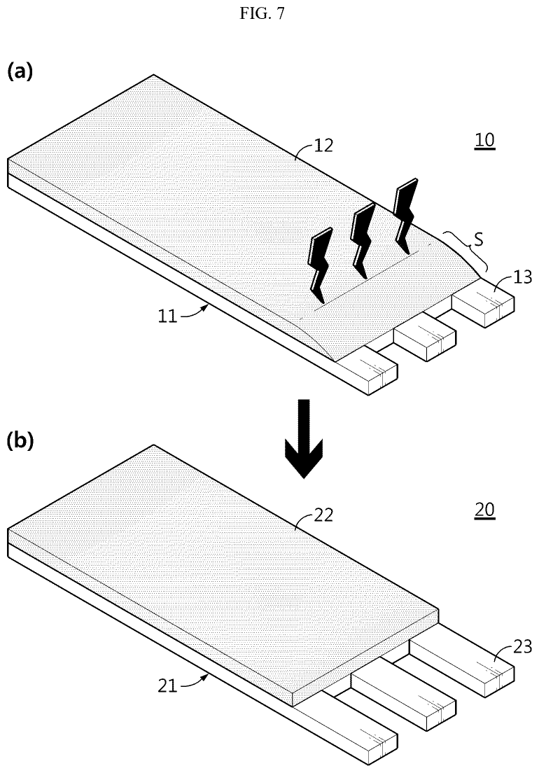

Referring to FIG. 7, the electrode 10 according to the related art is obtained by applying a slurry for an electrode layer onto at least one surface of an electrode current collector 11 in such a manner that a non-coated portion 13 may be formed at the top portion adjacent to one end of the current collector 11, followed by drying, to form an electrode layer 12 having a sliding portion S. Herein, the non-coated portion 13 may be formed into a tab portion through notching. Then, an etching process, such as laser ablation, is carried out to obtain an electrode 20 including an electrode layer 22 from which the sliding portion is removed on one surface of the current collector 11, and a non-coated portion also functioning as a tab portion 13 extended from the electrode layer.

According to an embodiment of the present disclosure, when removing the sliding portion of the electrode layer, the sliding portion may be removed to up to 10 mm of the electrode layer from the boundary between the end portion of the sliding portion and the non-coated portion before removing the sliding portion.

After removing the sliding portion to up to 10 mm of the electrode layer from the boundary between the end portion of the sliding portion and the non-coated portion before removing the sliding portion, it is possible to improve the adhesion between the electrode and a separator at the end portion.

After removing the sliding portion through laser ablation, the difference in thickness between the central portion of the electrode layer and the end portion thereof may be 3 μm or less, or the slope of the end portion of the electrode layer may be 80-90°, wherein the slope of the end portion refers to an angle formed between the surface of the current collector and a straight line connecting a boundary point at which the end portion of the electrode layer contacts the current collector with an inflection point at which the height of the central portion starts to be reduced and is linked to the end portion.

According to an embodiment of the present disclosure, when etching residue remains in the end portion of the electrode layer, or the like, after carrying out laser ablation (laser etching), a step of removing the etching residue may be further carried out after removing the sliding portion by using laser ablation. For example, the etching residue may be removed by blowing air to the end region of the electrode layer with a compressor, or the like.

In still another aspect of the present disclosure, there is provided a secondary battery including a positive electrode, a negative electrode and a separator interposed between the positive electrode and the negative electrode, wherein the positive electrode or the negative electrode is the same electrode as defined according to an embodiment of the present disclosure.

There is no particular limitation in the separator used in combination with the electrode according to the present disclosure. The separator is interposed between the positive electrode and the negative electrode to separate them from each other and includes an insulating thin film having high ion permeability and mechanical strength. Any separator may be used with no particular limitation, as long as it is one used generally for a secondary battery. Particular examples of the separator include a porous polymer film, such as a porous polymer film made of ethylene homopolymer, propylene homopolymer, ethylene/butene copolymer, ethylene/butene copolymer, ethylene/hexene copolymer, ethylene/methacrylate copolymer, or the like, or a laminated structure of two or more layers of such porous polymer films. In addition, a conventional porous non-woven web, such as a non-woven web made of high-melting point glass fibers, polyethylene terephthalate fibers, or the like, may be used.

In addition, a separator coated with inorganic particles, a binder polymer or a mixture of inorganic particles with a binder polymer may be used in order to ensure the heat resistance and mechanical strength, optionally in the form of a monolayer structure or multilayer structure. Further, when a solid electrolyte, such as a polymer, is used as an electrolyte, the solid electrolyte may function also as a separator.

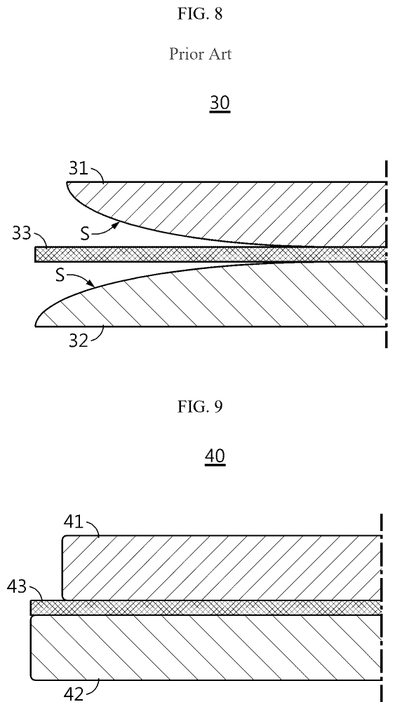

FIG. 8 is a schematic sectional view illustrating the electrode assembly according to the related art, and FIG. 9 is a schematic sectional view illustrating the electrode assembly according to an embodiment of the present disclosure.

Referring to FIG. 8 and FIG. 9, the electrode assembly 30 according to the related art includes a separator 33 interposed between a positive electrode 31 and a negative electrode layer 32 provided with a sliding portion S of electrode layer. Meanwhile, the electrode assembly 40 according to an embodiment of the present disclosure includes a separator 43 interposed between a negative electrode 42 and a positive electrode 41 including an electrode layer from which the sliding portion is removed and having a slope of the end portion of the electrode layer of 80-90°.

As compared to FIG. 8, in the electrode assembly as shown in FIG. 9, sliding is improved to provide improved adhesion between the separator and the electrode, inhibit a reversal phenomenon of capacity balance (N/P balance) between a positive electrode and a negative electrode, and inhibit over-voltage, so that deposition and side reactions at the end portion or top end portion are inhibited.

Particularly, inhibition of over-voltage is a phenomenon which results from improvement of close adhesion between an electrode and a separator and a decrease in physical distance between a positive electrode and a negative electrode. When a gradient in lithium-ion concentration between the positive electrode and the negative electrode is generated and lithium-ion concentration is decreased, ion conductivity is reduced to cause an increase in resistance and generation of over-voltage.

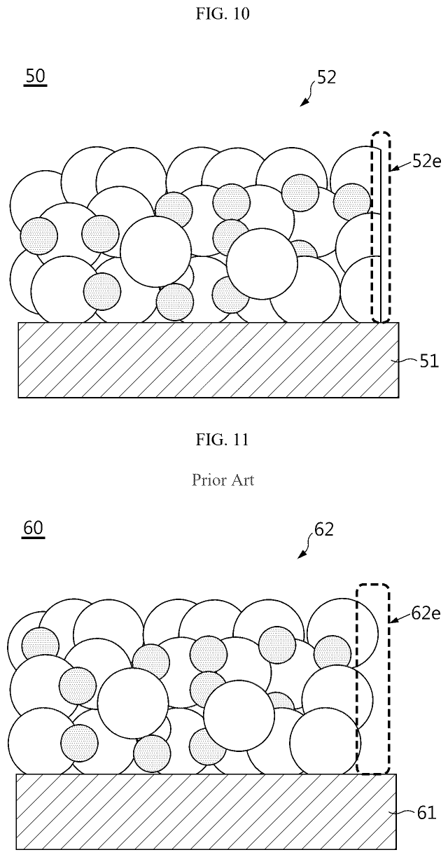

FIG. 10 is a schematic sectional view illustrating the electrode according to an embodiment of the present disclosure.

Referring to FIG. 10, the electrode 50 according to an embodiment of the present disclosure is provided with an electrode layer 52 disposed on a current collector 51, and the end portion 52e of the electrode layer has a slope of the end portion of 80-90°. In addition, the end portion 52e of the electrode layer according to an embodiment of the present disclosure may be essentially provided with a flat surface (etched surface) removed by using laser ablation (laser etching).

Meanwhile, FIG. 11 is a schematic sectional view illustrating the electrode according to the related art. According to the related art, the sliding portion of the end portion of an electrode may be removed by applying mechanical force, for example by attaching a tape to the sliding portion and tearing it off. In other words, the electrode 60 according to the related art is provided with an electrode layer 62 disposed on a current collector 61, but the end portion 62e of the electrode layer is removed by tearing it off by means of the adhesion of the tape. As a result, the shape of the active material remaining in the end portion 62e after the tearing is directly reflected to the end portion, and thus the end portion essentially has surface irregularities.

According to the present disclosure, the secondary battery may be a lithium secondary battery, including a lithium metal secondary battery, a lithium-ion secondary battery, a lithium polymer secondary battery or a lithium-ion polymer secondary battery.

### MODE FOR DISCLOSURE

Examples will be described more fully hereinafter so that the present disclosure can be understood with ease. The following examples may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art.

### Example 1

LiCoO₂ as a positive electrode active material, carbon black and polyvinylidene fluoride (PVDF) were introduced to N-methyl pyrrolidone (NMP) at a weight ratio of 98:1:1 and mixed therein to prepare a positive electrode slurry. Then, the positive electrode slurry was applied to a current collector made of aluminum foil at a loading amount of 18.7 mg/cm² based on dry weight, followed by drying, to form a positive electrode layer, and the current collector having the positive electrode layer was pressed to an electrode density of 4.0 g/cc. After the pressing, a femtosecond laser device was used to remove the sliding portion of the electrode layer formed at the boundary portion with the non-coated portion under the conditions of wavelength of 1030 nm, repetition ratio 200 kHz, output 3 W. In this manner, a positive electrode having a slope of the end portion of the positive electrode layer of 87° was obtained, after removing the sliding portion. Herein, the slope of the end portion of the positive electrode layer refers to an angle formed by a boundary point at which the end portion of the positive electrode layer contacts the current collector, between the tangent line in contact with the end portion and one surface of the current collector facing the positive electrode layer.

Then, 96 parts by weight of artificial graphite as a negative electrode active material, 0.5 parts by weight of acetylene black as a conductive material, 1.0 parts by weight of carboxymethyl cellulose (CMC) as a thickener and 2.5 parts by weight of styrene butadiene rubber (SBR) as a binder were added to and mixed with water to prepare a negative electrode slurry. Next, the negative electrode slurry was applied to a copper (Cu) current collector to a loading amount of 10.1 mg/cm² based on dry weight, followed by drying, to form a negative electrode layer, and the current collector having the negative electrode layer was pressed to an electrode density of 1.7 g/cc. After the pressing, a femtosecond laser device was used to remove the sliding portion of the negative electrode layer formed at the boundary portion with the non-coated portion under the conditions of wavelength of 1070 nm, repetition ratio 500 kHz, output 10 W. In this manner, a negative electrode having a slope of the end portion of the negative electrode layer of 87° was obtained, after removing the sliding portion. Herein, the slope of the end portion of the negative electrode layer refers to an angle formed by a boundary point at which the end portion of the negative electrode layer contacts the current collector, between the tangent line in contact with the end portion and one surface of the current collector facing the negative electrode layer.

After that, the electrodes are stacked with a separator, the resultant structure was introduced to a pouch-type battery casing, and an electrolyte was injected thereto to obtain a battery. The electrolyte was prepared by mixing ethylene carbonate, propylene carbonate, ethyl propionate and propyl propionate at a weight ratio of 2:1:2.5:4.5 and introducing LiPF₆ thereto at a concentration of 1.2 M.

### Comparative Example 1

LiCoO₂ as a positive electrode active material, carbon black and PVDF were introduced to NMP at a weight ratio of 98:1:1 and mixed therein to prepare a positive electrode slurry. Then, the positive electrode slurry was applied to a current collector made of aluminum foil at a loading amount of 18.7 mg/cm² based on dry weight, followed by drying, to form a positive electrode layer, and the current collector having the positive electrode layer was pressed to an electrode density of 4.0 g/cc to obtain a positive electrode. Herein, the slope of the end portion of the positive electrode layer was 60°.

Then, 96 parts by weight of artificial graphite as a negative electrode active material, 0.5 parts by weight of acetylene black as a conductive material, 1.0 parts by weight of carboxymethyl cellulose (CMC) as a thickener and 2.5 parts by weight of styrene butadiene rubber (SBR) as a binder were added to and mixed with water to prepare a negative electrode slurry. Next, the negative electrode slurry was applied to a copper (Cu) current collector to a loading amount of 10.1 mg/cm² based on dry weight, followed by drying, to form a negative electrode layer, and the current collector having the negative electrode layer was pressed to an electrode density of 1.7 g/cc to obtain a negative electrode. Herein, the slope of the end portion of the negative electrode layer was 60°.

After that, the electrodes are stacked with a separator, the resultant structure was introduced to a pouch-type battery casing, and an electrolyte was injected thereto to obtain a battery. The electrolyte was prepared by mixing ethylene carbonate, propylene carbonate, ethyl propionate and propyl propionate at a weight ratio of 2:1:2.5:4.5 and introducing LiPF₆ thereto at a concentration of 1.2 M.

### <Evaluation of Room-Temperature Cycle Characteristics>

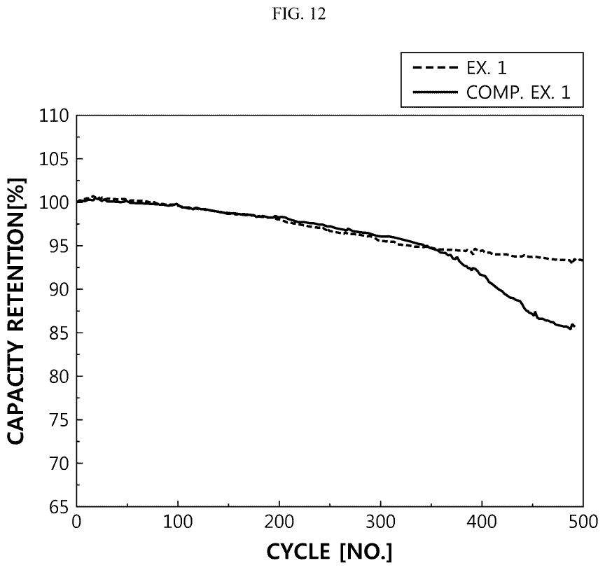

The battery according to each of Example 1 and Comparative Example 1 was charged at 2.0 C in a constant current (CC) mode to a 4.45 V and in a constant voltage (CV) mode to a charge cut-off current of 0.005 C, and discharged at 1 C in a constant current mode to 3 V. Such a charge/discharge cycle was repeated 500 times (500 cycles), and the capacity retention at each cycle was evaluated. The result is shown in FIG. 12. The test was carried out at room temperature (25° C.).

The capacity retention of each battery was calculated from the result according to the following formula:

Capacity retention after N^{th} cycle (%)=(Capacity at N^{th} cycle/Initial capacity)×100 (wherein N is 2-500)

Referring to FIG. 12, it can be seen that the battery according to Example 1 shows excellent cycle characteristics and maintains a capacity retention of about 93% or more as compared to the initial capacity even after carrying out 500 charge/discharge cycles, while the battery according to Comparative Example 1 shows a decrease in capacity retention to a level of 85% after carrying out 500 charge/discharge cycles.

What is claimed is:

1. An electrode comprising: a current collector; and an electrode layer disposed on at least one surface of the current collector and a non-coated portion having no electrode layer,
wherein the vertical section of the electrode layer is provided with a central portion of the electrode layer, and an end portion that is extended from each of both sides of the central portion of the electrode layer and is in contact with the current collector, while the height of the central portion of the electrode layer decreases,
the electrode layer shows a slope of the end portion of 80-90°, and
the slope of the end portion refers to an angle formed by a boundary point at which the end portion of the electrode layer contacts the current collector, between the tangent line in contact with the end portion and one surface of the current collector facing the electrode layer.

2. The electrode according to claim 1, wherein the electrode layer shows a slope of the end portion of 85-90°.

3. The electrode according to claim 1, wherein the electrode layer has a length of the end portion of 10 mm or less,
the length of the end portion refers to a distance between a vertically downward facing point of the slope start point to the current collector and a boundary point at which the end portion of the electrode layer contacts the current collector, and
the slope start point is a position on the end portion having an acute angle of 10° or more for the first time, when the acute angle formed by an extension line of the central portion of the electrode layer and the tangent line on the end portion along the end portion extended from the central portion is measured.

4. A method for manufacturing the electrode as defined in claim 1, comprising the steps of:
applying a slurry for an electrode layer to at least one surface of an electrode current collector in such a manner that a non-coated portion may be formed at the top end portion adjacent to one end of the current collector, followed by drying, to form an electrode layer;
pressing the electrode current collector on which the electrode layer is formed; and
removing a sliding portion of the electrode layer formed at the boundary portion to the non-coated portion after the pressing.

5. The method for manufacturing the electrode according to claim 4, wherein the sliding portion is removed by using laser ablation.

6. The method for manufacturing the electrode according to claim 5, wherein the laser ablation is carried out by using a femtosecond laser.

7. The method for manufacturing the electrode according to claim 4, wherein the sliding portion of the electrode layer is removed after the pressing, or after the pressing and notching.

8. The method for manufacturing the electrode according to claim 4, wherein the sliding portion of the electrode layer is removed up to 10 mm or less from the boundary with the non-coated portion.

9. A secondary battery comprising the electrode as defined in any one of claims 1 to 3.

10. The secondary battery according to claim 9, which is a lithium secondary battery.
